(19) United States
(12) Patent Application Publication
(10) Pub. No.: US 2025/0170676 A1
(43) Pub. Date: May 29, 2025

(54) LASER WELDING METHOD AND METAL JOINT BODY

(71) Applicants: NICHIA CORPORATION, Anan-shi, Tokushima (JP); FURUKAWA ELECTRIC CO., LTD., Chiyoda-ku, Tokyo (JP)

(72) Inventors: Keita YAMAMOTO, Yokohama-shi, Kanagawa (JP); Hideki KONDO, Yokohama-shi, Kanagawa (JP); Naoki MORI, Yokohama-shi, Kanagawa (JP); Toshiaki SAKAI, Tokyo (JP); Nobuyasu MATSUMOTO, Tokyo (JP); Masamitsu KANEKO, Tokyo (JP); Takashi SHIGEMATSU, Tokyo (JP)

(21) Appl. No.: 18/837,583

(22) PCT Filed: Feb. 13, 2023
(86) PCT No.: PCT/JP2023/004861

§ 371 Date: Aug. 9, 2024

(30) Foreign Application Priority Data
Feb. 15, 2022 (JP) 2022-021668
May 25, 2022 (JP) 2022-085594

(51) Int. Cl. B23K 26/21; F16B 5/08

(52) U.S. Cl. CPC B23K 26/21; F16B 5/08

(57) ABSTRACT

Provided is a laser welding method for welding a metal material and a laminated body of metal foil together by irradiation with laser light. The laser welding method includes: a first step of forming a first weld part in which at least a plurality of the metal foils included in the laminated body are welded by emitting the laser light; and a second step of welding the laminated body and the metal material together by irradiating the laser light onto a region at least partially including the first weld part.

### CROSS-REFERENCE TO RELATED APPLICATIONS

This application is a U.S. national stage application of International Application No. PCT/JP2023/004861, filed on Feb. 13, 2023, which claims priority to Japanese Patent Application No. 2022-021668, filed on Feb. 15, 2022, and Japanese Patent Application No. 2022-085594, filed on May 25, 2022.

### TECHNICAL FIELD

The present invention relates to a laser welding method and a metal joint body.

### BACKGROUND

Conventionally, for example, there is known a power storage device including a part where a metal material and a plurality of metal foils are joined by laser welding (for example, Japanese Patent Application Laid-open No. 2020-004643).

### SUMMARY

In laser welding for joining a metal material with a plurality of metal foils, the metal foil is thin and easily stretched or broken due to irradiation of laser light, which complicates setting conditions for the laser welding in some cases.

Thus, for example, one object of the present invention is to provide a new improved laser welding method and metal joint body in which the metal foil can be inhibited from being excessively stretched or broken in joining the metal material with a plurality of metal foils, for example, by laser welding.

A laser welding method according to the present invention is, for example, a laser welding method for welding a metal material to a laminated body of metal foil by irradiating with laser light, the laser welding method including: a first step of forming a first weld part in which at least a plurality of the metal foils included in the laminated body are welded by emitting the laser light; and a second step of welding the laminated body to the metal material by emitting the laser light onto a region at least partially including the first weld part.

A metal joint body according to the present invention includes, for example: a metal material; a laminated body of metal foil placed on the metal material; and a weld part including a penetration part passing through the laminated body in a laminating direction of the metal foil and a projecting part projecting from the penetration part into the metal material, the weld part being configured to weld the laminated body to the metal material, wherein a minimum width of a region in which the penetration part is formed is larger than a maximum width of the projecting part, or a minimum diameter of a region in which the penetration part is formed is larger than a maximum diameter of the projecting part.

According to the present invention, for example, it is possible to obtain a new improved laser welding method and metal joint body that can inhibit the metal foil from being excessively stretched or broken in joining the metal material and the plurality of metal foils together by laser welding.

### BRIEF DESCRIPTION OF DRAWINGS

FIG. 1 is an exemplary and schematic configuration diagram of a laser processing device according to an embodiment.

FIG. 2 is an exemplary and schematic cross-sectional view of a battery including a metal joint body as a processing object of the laser processing device according to the embodiment.

FIG. 3 is a graph indicating a light absorption rate of metal with respect to a wavelength of emitted laser light.

FIG. 4 is an exemplary and schematic plan view illustrating a spot of laser light formed on a surface of the processing object by the laser processing device according to the embodiment.

FIG. 5 is an exemplary flowchart illustrating a procedure of a laser welding method according to the embodiment.

FIG. 6 is an exemplary and schematic cross-sectional view of the processing object at a stage where a first step of the laser welding method according to a first embodiment is ended.

FIG. 7 is an exemplary and schematic cross-sectional view of a metal joint body welded by the laser welding method according to the first embodiment.

FIG. 8 is a timing chart illustrating an example of a temporal change in power of laser light emitted in the first step of the laser welding method according to the embodiment.

FIG. 9 is an exemplary and schematic plan view illustrating an irradiation region of the laser light formed on the surface of the processing object in the first step of the laser welding method according to the embodiment.

FIG. 10 is an exemplary and schematic cross-sectional view of the processing object at a stage where the first step of the laser welding method according to a second embodiment is ended.

FIG. 11 is an exemplary and schematic cross-sectional view of a metal joint body welded by the laser welding method according to the second embodiment.

FIG. 12 is an exemplary flowchart illustrating a procedure of a laser welding method according to a third embodiment.

FIG. 13 is an exemplary and schematic cross-sectional view of the processing object at a stage in the middle of a third step of the laser welding method according to the third embodiment.

FIG. 14 is an exemplary and schematic cross-sectional view of the processing object at a stage where the third step of the laser welding method according to the third embodiment is ended.

FIG. 15 is an exemplary and schematic cross-sectional view of the processing object at a stage where a second step of the laser welding method according to the third embodiment is ended.

FIG. 16 is an exemplary and schematic cross-sectional view of the processing object at a stage in the middle of the third step of the laser welding method according to a modification in which an irradiation direction of laser light in the third embodiment is changed.

FIG. 17 is a schematic cross-sectional view in an example different from FIGS. 7 and 11 of the metal joint body welded by the laser welding method according to the embodiment.

### DESCRIPTION OF EMBODIMENTS

The following discloses exemplary embodiments of the present invention. Configurations in the following embodiments, and an operation and an effect exhibited by the configurations are merely examples. The present invention can also be implemented by configurations other than the configurations disclosed in the following embodiments. According to the present invention, it is possible to obtain at least one of various effects (including derivative effects) that are obtained by the configurations.

In the respective drawings, an X-direction is represented by an arrow X, a Y-direction is represented by an arrow Y, and a Z-direction is represented by an arrow Z. The X-direction, the Y-direction, and the Z-direction intersect with and are orthogonal to each other. The Z-direction is a direction normal to a surface Wa of a processing object W, a thickness direction of a metal material 11 and metal foil 12, and a laminating direction of a plurality of the metal foils 12.

In the present specification, ordinal numbers are given for convenience' sake to distinguish processes, parts, portions of laser light, time periods, and the like from each other, and do not limit priority or order.

### First Embodiment

### Configuration of Laser Processing Device

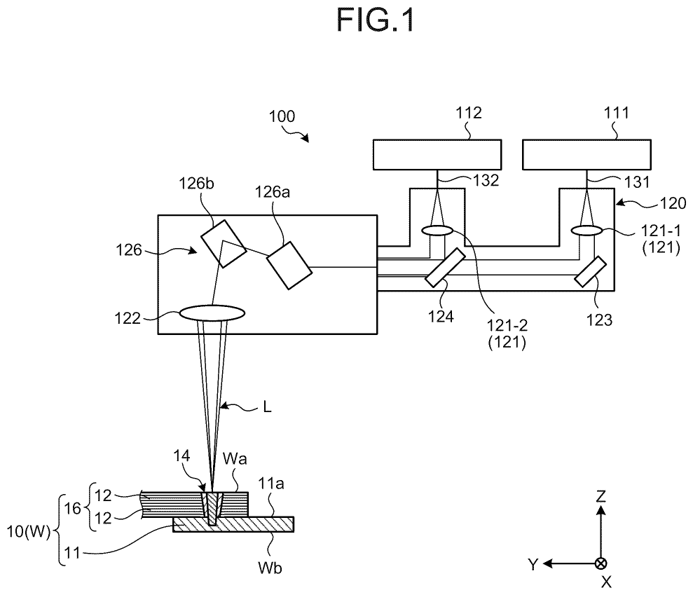

FIG. 1 is a schematic configuration diagram of a laser processing device 100 according to a first embodiment. As illustrated in FIG. 1, the laser processing device 100 includes a laser device 111, a laser device 112, an optical head 120, and optical fibers 131 and 132. The laser processing device 100 is configured to subject the processing object W to laser welding by irradiating laser light L thereto. The laser processing device 100 is also referred to as a laser welding device.

Each of the laser devices 111 and 112 includes a laser oscillator, and is configured to be able to output laser light having power of several kilowatts, for example. Each of the laser devices 111 and 112 outputs laser light having a wavelength equal to or larger than 400 nm and equal to or smaller than 1200 nm. Each of the laser devices 111 and 112 includes therein a laser light source such as a fiber laser, a semiconductor laser (element), a YAG laser, and a disk laser, for example. Each of the laser devices 111 and 112 may be configured to be able to output multi-mode laser light having power of several kilowatts as a total output of a plurality of light sources. The laser device 111 outputs first laser light, and the laser device 112 outputs second laser light.

Each of the optical fibers 131 and 132 optically connects a respective one of the laser devices 111 and 112 and the optical head 120. In other words, each of the optical fibers 131 and 132 guide portions of laser light output from the laser devices 111 and 112, respectively, to the optical head 120.

The optical head 120 is an optical device configured to cause the laser light, input from the laser devices 111 and 112, to irradiate the processing object W. The optical head 120 includes collimating lenses 121, a condensing lens 122, a mirror 123, a filter 124, and a galvanoscanner 126. The collimating lenses 121, the condensing lens 122, the mirror 123, the filter 124, and the galvanoscanner 126 are also referred to as optical components.

The collimating lenses 121 (121-1, 121-2) collimate the laser light input via the optical fibers 131 and 132, respectively. The collimated laser light becomes collimated light.

The mirror 123 reflects the first laser light that has become the collimated light through the collimating lens 121-1 toward the galvanoscanner 126.

The filter 124 is a high-pass filter that transmits the first laser light, and does not transmit but reflects the second laser light. The first laser light from the mirror 123 is transmitted through the filter 124 and travels to the galvanoscanner 126. On the other hand, the second laser light from the collimating lens 121-2 is reflected by the filter 124 and travels to the galvanoscanner 126.

The galvanoscanner 126 includes a plurality of mirrors 126a and 126b. An output direction of the laser light L from the optical head 120 can be switched by changing angles of the mirrors 126a and 126b, and an irradiation position of the laser light L on the surface Wa of the processing object W can be changed accordingly. Each of the angles of the mirrors 126a and 126b is changed by a motor controlled by a control device (both are not illustrated), for example. The optical head 120 is configured to change the output direction of the laser light L while emitting the laser light L, and thus can perform scanning with the laser light L on the surface Wa of the processing object W.

The condensing lens 122 condenses the laser light as collimated light emitted by the galvanoscanner 126, and cause it as the laser light L (output light) to irradiate the processing object W. The laser light L output from the optical head 120 includes the first laser light and the second laser light.

The processing object W includes the metal material 11 and a laminated body 16 of the metal foils 12 disposed on the metal material 11. The metal material 11 is a metal in which a part to be welded and a peripheral portion thereof, for example, extends intersecting with the Z-direction. The laminated body 16 includes a plurality of metal foils 12 laminated in the Z-direction while being arranged to intersect with the Z-direction at the part to be welded and the peripheral portion thereof.

The metal material 11 and the laminated body 16 are overlapped with each other in the Z-direction. The laminated body 16 is overlapped on a surface 11a positioned at an end part in the Z-direction of the metal material 11. A surface positioned at an end thereof in the Z-direction of the laminated body 16 is the surface Wa of the processing object W, and a surface positioned at an end thereof in a direction opposite to the Z-direction of the metal material 11 is a back surface Wb of the processing object W. The laser light L from the optical head 120 is output substantially along a minus direction of the Z-direction, and is irradiated onto the surface Wa. When the galvanoscanner 126 operates, the spot of the laser light L is scanned on the surface Wa.

Irradiation of the laser light L forms a weld part 14 that penetrates the laminated body 16 from the surface Wa and reaches the inside of the metal material 11, resulting in formation of the metal joint body 10 in which the metal material 11 and the laminated body 16 are joined together via the weld part 14. In other words, the metal joint body 10 includes the metal material 11, the laminated body 16, and the weld part 14. The weld part 14 is also referred to as a weld metal.

Each of the metal material 11, the plurality of metal foils 12, and the weld part 14 is a conductor. The weld part 14 electrically connects the metal material 11 with the plurality of metal foils 12. The metal material 11 and the metal foil 12 are made of pure aluminum or aluminum-based metal such as an aluminum alloy, for example. However, the metal material 11 and the metal foils 12 may be made of a material different from the aluminum-based metal such as oxygen free copper or copper-based metal such as a copper alloy.

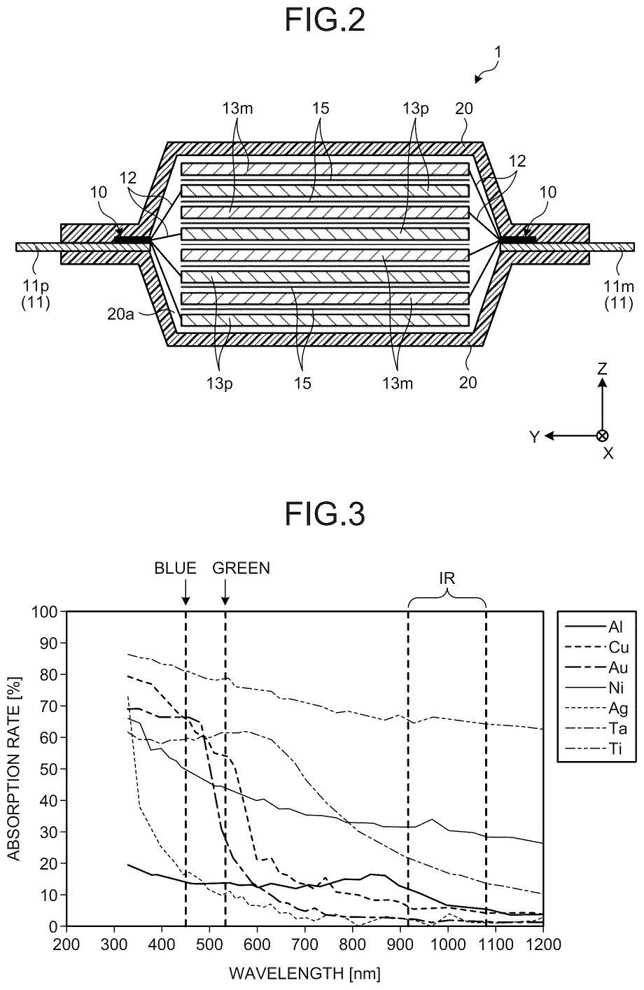

FIG. 2 is a cross-sectional view of a battery 1 as an electric product including the metal joint body 10. The battery 1 is an application example of the metal joint body 10. In this case, the metal joint body 10 is an example of an electric component serving as a conductor, and is an example of an electric component included in the electric product. The electric component may also be referred to as a constituent part of the electric product.

The battery 1 illustrated in FIG. 2 is a laminate-type lithium ion battery cell, for example. The battery 1 includes two film-shaped exterior materials 20. A housing chamber 20a is formed between the two exterior materials 20. The housing chamber 20a houses a plurality of flat cathode materials 13p, a plurality of flat anode materials 13m, and a plurality of flat separators 15. In the housing chamber 20a, the cathode material 13p and the anode material 13m are alternately laminated with the separator 15 disposed therebetween. Respective metal foils 12 extend from respective ones of the cathode materials 13p and respective ones of the anode materials 13m. In the example of FIG. 2, a plurality of metal foils 12, each extending from a respective one of the cathode materials 13p, are overlapped on a metal material 11p (11) at an end part of the battery 1 in the Y-direction, and the metal joint body 10 obtained by welding the metal material 11p (11) and the plurality of metal foils 12 is disposed at the end part. On a cathode side, only a part of the metal material 11p is exposed to the outside of the exterior material 20, and the other part of the metal material 11p, the plurality of metal foils 12, and the weld part 14 are not exposed to the outside of the exterior material 20. The metal material 11p constitutes a cathode terminal of the battery 1. On the other hand, a plurality of metal foils 12, each extending from a respective one of the anode materials 13m, are overlapped on a metal material 11m (11) at an end part of the battery 1 in a direction opposite to the Y-direction, and the metal joint body 10 obtained by welding the metal material 11m (11) and the plurality of metal foils 12 is disposed at the end part. Also on an anode side, only a part of the metal material 11m is exposed to the outside of the exterior material 20, and the other part of the metal material 11m, the plurality of metal foils 12, and the weld part 14 are not exposed to the outside of the exterior material 20. The metal material 11m constitutes an anode terminal of the battery 1.

### Wavelength and Light Absorption Rate

The following describes a light absorption rate of the metallic material. FIG. 3 is a graph indicating the light absorption rate of each metallic material with respect to a wavelength of the emitted laser light L. A horizontal axis of the graph in FIG. 3 indicates the wavelength, and a vertical axis indicates the absorption rate. FIG. 3 illustrates a relation between the wavelength and the absorption rate of each of aluminum (Al), copper (Cu), gold (Au), nickel (Ni), silver (Ag), tantalum (Ta), and titanium (Ti).

Although respective materials have different characteristics, it can be understood that metals illustrated in FIG. 3 has higher absorption rate of light energy when using blue or green laser light having a shorter wavelength rather than using laser light of infrared rays (IR).

In a case in which the laser light having a relatively low absorption rate and a relatively long wavelength is emitted onto the processing object W, light energy is reflected by the processing object W, so that the processing object W is hardly influenced by heat. Thus, relatively high power needs to be applied for obtaining a melting region having a sufficient depth. In this case, energy is abruptly input to a beam center part, so that sublimation is caused, and a keyhole is formed. However, irradiation of high-power laser light may cause a molten pool to be unstable, which may cause spatters or voids. In a case in which the processing object W includes the metal foil 12, the metal foil 12 is thin, so that it may be stretched or broken more easily.

In contrast, in a case in which the laser light having a relatively high absorption rate and a relatively short wavelength is emitted onto the processing object W, most of the input light energy is absorbed by the processing object W, and thus thermal energy can be easily obtained. That is, a keyhole is not formed, and melting of thermal conductive type is performed, so that the molten pool tends to be stabilized.

Thus, in the present embodiment, the laser light L including two laser lights (the first laser light and the second laser light) having different wavelengths is output from the optical head 120, and the laser light L is irradiated onto the surface Wa of the processing object W to weld the metal material 11 and the laminated body 16 together.

The laser device 111 (refer to FIG. 1) outputs laser light having a wavelength equal to or larger than 800 nm and equal to or smaller than 1200 nm, for example, as the first laser light having a wavelength longer than that of the second laser light. The laser device 111 includes, as a laser light source, a fiber laser or a semiconductor laser (element), for example.

The laser device 112 outputs laser light having a wavelength equal to or smaller than 550 nm, for example, as the second laser light having a wavelength shorter than that of the first laser light. The laser device 112 includes a semiconductor laser (element) as the laser light source, for example. More preferably, the laser device 112 outputs the second laser light having a wavelength equal to or larger than 400 nm and equal to or smaller than 500 nm and thus having a higher absorption rate.

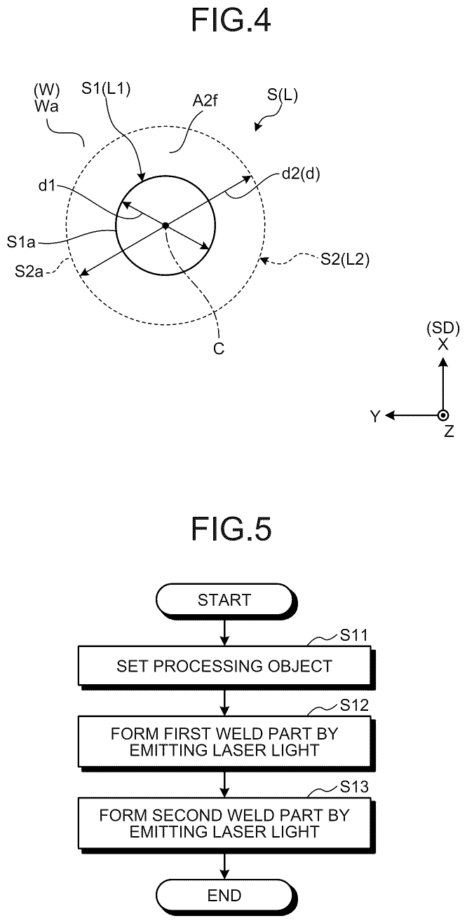

FIG. 4 illustrates an example of a spot S of the laser light L formed on the surface Wa. As illustrated in FIG. 4, the spot S of the laser light L includes a spot S1 of first laser light L1 and a spot S2 of second laser light L2.

The spots S, S1, and S2 are instantaneous irradiation regions of the laser light. d, d1, and d2 indicate diameters of the spots S, S1, and S2, respectively. In the present embodiment, as illustrated in FIG. 4, the size of the spot S2 (diameter d2) is larger than the size (diameter d1) of the spot S1, and the spot S1 is positioned within the spot S2. In other words, an outer edge S1a of the spot S1 is positioned inward of an outer edge S2a of the spot S2. By setting the spots S1 and S2 as described above, thermal energy generated by emitting the second laser light L2 can be given to the irradiation region of the first laser light L1 from the periphery thereof, so that a deeper molten pool can be easily formed with smaller energy as compared with a case of irradiating the first laser light L1 singly. Additionally, a temporal temperature change of the molten pool can be reduced, so that the molten pool can be further stabilized, which allows for obtaining effects of reducing generation of spatters or voids and inhibiting the metal foil 12 from being easily stretched or broken.

In a case in which the spot S of the laser light L is scanned in a scanning direction SD on the surface Wa, at least a partial region A2f of the spot S2 is preferably positioned on a forward side in the scanning direction SD with respect to the spot S1. With this arrangement, in a case in which the spot S (laser light L) is scanned, the region (spot S1) to be irradiated with the first laser light L1 can be preheated by the second laser light L2. Also in this case, a deeper molten pool can be easily formed with smaller energy as compared with a case of irradiating with the first laser light L1 singly. Additionally, a temporal temperature change of the molten pool can be reduced, so that the molten pool can be further stabilized, which allows for obtaining effect of reducing generation of spatters or voids and inhibiting the metal foil 12 from being easily stretched or broken.

In the example of FIG. 4, a center C of the spot S1 and the center C of the spot S2 overlap with each other, but the two centers may be offset from each other. For example, the spot S1 may partially protrude from the spot S2 toward a backward side in the scanning direction SD. Each of the diameters of the spots S1 and S2 on the surface Wa can be defined as a diameter of a region at which the intensity is equal to or larger than 1/e² of peak intensity. In a case of a spot not having a circular shape, a length in a direction (width direction) orthogonal to the scanning direction SD and orthogonal to the Z-direction of the region at which the intensity is equal to or larger than 1/e² of the peak intensity can be defined as a diameter or a width of the spot.

In a case in which scanning is performed in the scanning direction SD on the surface Wa with the laser light L, the weld part 14 extends in the scanning direction SD in the cross-sectional shape of FIG. 1.

### Laser Welding Method

FIG. 5 is a flowchart illustrating an example of a procedure of laser welding of the processing object W by the laser processing device 100. First, by using a jig and the like (not illustrated), the processing object W in which the metal material 11 and the plurality of metal foils 12 are integrally held is set on a support (not illustrated) so that the laser light L can be irradiated onto the surface Wa (S11).

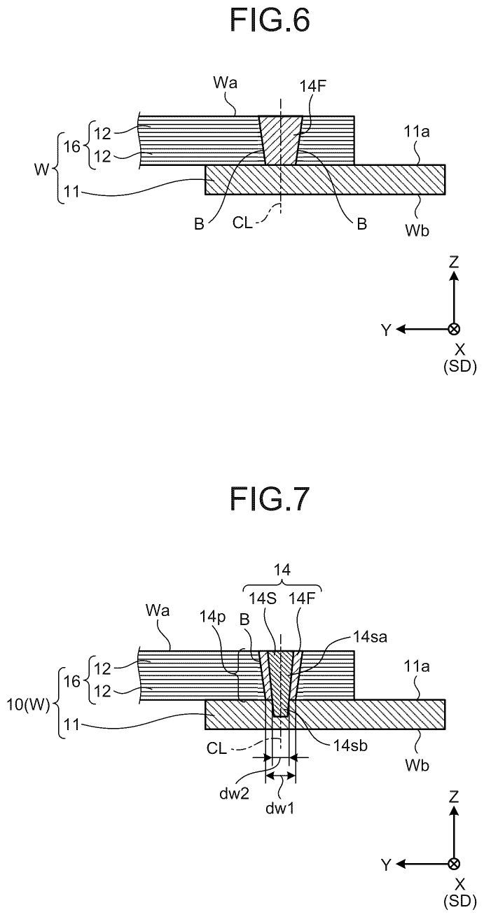

Next, S12 and S13 are performed. FIG. 6 is a cross-sectional view of the processing object W on which a first weld part 14F is formed in S12, and FIG. 7 is a cross-sectional view of the processing object W (metal joint body 10) on which a second weld part 14S is formed in S13.

As described above, the metal foil 12 is thin, so that it is easily stretched or broken at the time of welding as compared with a metal material and the like having a larger thickness. Such a break or excessive stretch of the metal foil 12 will cause, in addition to lack of strength of the metal joint body 10, insulation, a conduction failure, increase in electric resistance, and the like in a case of using the metal foil 12 as a conductor, and thus should be avoided. Further, in a case in which the processing object W includes the metal material 11 in addition to the plurality of metal foils 12 as in the present embodiment, it is more difficult to join the plurality of metal foils 12 (laminated body 16) and the metal material 11 together by one time of irradiation of the laser light L while inhibiting a break or excessive stretch of the metal foil 12.

Thus, in the present embodiment, first, in S12, a plurality of metal foils 12 are joined to be integrated by the first weld part 14F under a condition with which the metal foil 12 is hardly stretched or broken. Then, in S13, the second weld part 14S is formed to join the metal material 11 with the first weld part 14F as a part in which the plurality of metal foils 12 are integrated.

First, in S12 (refer to FIG. 6), when the laser light L is emitted, the surface Wa of the processing object W is irradiated with the laser light L, and the molten pool formed by irradiation of the laser light L is cooled and solidified to form the first weld part 14F in which the plurality of metal foils 12 included in the laminated body 16 are welded. S12 is an example of a first step.

Herein, as illustrated in FIG. 6, the first weld part 14F formed in S12 extends in the minus direction of the Z-direction from the surface Wa and penetrates the laminated body 16, but does not reach the metal material 11. That is, the first weld part 14F formed in S12 is not welded to the metal material 11. Through experimental researches by the inventors, it has been found that a joint failure tends to occur in the metal joint body 10 if the first weld part 14F is formed to reach the metal material 11. If the molten pool to be the first weld part 14F is formed in a form of entering the metal material 11, heat of the molten pool is easily transmitted to the metal material 11 as compared with a case in which the molten pool does not enter the metal material 11. Additionally, it is difficult to control an amount of the molten pool entering the metal material 11 to be constant. Thus, it is assumed that, if the molten pool is formed in a form of entering the metal material 11, an amount of heat transfer via the metal material 11 varies depending on a position or an individual of the metal joint body 10, which results in causing a joint failure as described above. An alternate long and short dash line CL in the drawing indicates a center line passing through the center C of the spot S of the laser light L along the Z-direction. In the example of FIG. 6, the scanning direction SD is the X-direction, and a width direction with respect to scanning is the Y-direction, but the scanning direction SD is not limited to the X-direction.

Next, in S13 (see FIG. 7), the laser light L is irradiated onto a region including at least s part of the first weld part 14F on the surface Wa of the processing object W, and the molten pool formed by irradiation of the laser light L is cooled and solidified to form the second weld part 14S. As illustrated in FIG. 7, the second weld part 14S formed in S13 penetrates the first weld part 14F and reaches the metal material 11. That is, the second weld part 14S welds the first weld part 14F to the metal material 11. Accordingly, the metal joint body 10 has a configuration in which the laminated body 16 and the metal material 11 are joined together by the weld part 14 including the first weld part 14F and the second weld part 14S. S13 is an example of a second step.

In S13, the second weld part 14S includes a part in which the first weld part 14F is molten and solidified. The first weld part 14F is a part in which the plurality of metal foils 12 are integrated to be a lump in S12, so that the plurality of metal foils 12 are not present in the first weld part 14F. Thus, in forming the second weld part 14S in S13, the metal foil 12 is not broken or stretched at a part where the first weld part 14F is molten to be the second weld part 14S. Thus, as in the present embodiment, in S13, when the laser light L is emitted onto the region including at least part of the first weld part 14F on the surface Wa of the processing object W, and at least a part of the first weld part 14F is molten and solidified to form the second weld part 14S, so that a break or excessive stretch of the metal foil 12 can be reduced.

In welding of the metal foil 12, the metal foil 12 may be broken to form a gap at a boundary between the weld part and the metal foil 12, or the metal foil 12 may be stretched at a portion being in contact with the weld part to form a thin part that is excessively thin. This may be because a volume of the weld part is reduced when the weld part in a molten state is cooled to be solidified, and the metal foil 12 is pulled away from the weld part. Thus, as illustrated in FIG. 7, the second weld part 14S is preferably formed in a state of being separated from the plurality of metal foils 12 so that a boundary is not generated between (the molten pool of) the second weld part 14S and the metal foil 12. In a case of the present embodiment, the second weld part 14S preferably penetrates the first weld part 14F in a state of being separated from a boundary B (connecting portion) between the first weld part 14F and the plurality of metal foils 12. From such a viewpoint, the first weld part 14F is preferably formed to have a size (area) on the surface Wa and a size (volume) that allows the first weld part 14F to surround the second weld part 14S more securely.

To inhibit a break and excessive stretch of all of the plurality of metal foils 12, as illustrated in FIG. 6, all of the plurality of metal foils 12 included in the laminated body 16 are preferably welded in S12. However, in a situation where it has been found that a break or excessive stretch of the metal foil 12 tends to occur only in the vicinity of the surface Wa, it is sufficient that the first weld part 14F joins at least metal foils 12 close to the surface Wa in some cases. In other words, the first weld part 14F may extend from the surface Wa to the middle of the laminated body 16 without penetrating the laminated body 16, and does not necessarily join all of the plurality of metal foils 12 in some cases.

As illustrated in FIG. 7, the second weld part 14S formed in S13 includes a first part 14sa passing through the laminated body 16, and a second part 14sb extending from the first part 14sa in the minus direction of the Z-direction, that is, extending in a direction away from the surface Wa to project into the metal material 11, in other words, extending to the inside of the metal material 11. The weld part 14 is then in a form of including a penetration part 14p including the first weld part 14F and the first part 14sa of the second weld part 14S and penetrating the laminated body 16, and the second part 14sb of the second weld part 14S. The second part 14sb is an example of a projecting part.

In consideration of separating the second weld part 14S from the metal foil 12 more securely and inhibiting a break or excessive stretch of the metal foil 12 more securely, the weld part 14 is preferably formed so that the second part 14sb projects from the penetration part 14p into the metal material 11, and a minimum width dw1 of a region in which the penetration part 14p is formed is larger than a maximum width dw2 of the second part 14sb. In a case of not performing scanning with the laser light L and emitting the laser light L onto a fixed point in S12 and S13, the weld part 14 may be formed so that a minimum diameter (corresponding to dw1 in FIG. 7) of the region in which the penetration part 14p is formed is larger than a maximum diameter (corresponding to dw2 in FIG. 7) of the second part 14sb.

### Conditions for Laser Welding

Based on experimental researches, the present inventors have found that performing irradiation with the laser light L under predetermined conditions in S12 and S13 as described above allows for forming the preferable metal joint body 10 in which a break or excessive stretch of the metal foil 12 is inhibited. In the experiment, in S12 and S13, the first weld part 14F and the second weld part 14S, respectively, are formed by scanning the spot S of the laser light L on the surface Wa. By the scanning, the first weld part 14F and the second weld part 14S can be formed over a wider range in a shorter time period. In the experiment, in S12 and S13, the spot S of the laser light L was scanned on the same line (scanning section) on the surface Wa.

The experiment was conducted for a case in which the metal material 11 and twenty metal foils 12 are both made of aluminum-based metal. In both S12 and S13, the diameter dl of the spot S1 of the first laser light L1: 20to 40 (μm), and the diameter d2 of the spot S2 of the second laser light L2: 300 to 350 (μm) were set. In S12, power of the first laser light L1: 100 to 200 (W), power of the second laser light L2: 100 to 200 (W), and a scanning speed: 0.1 to 0.2 (m/sec) were assumed, and in S13, the power of the first laser light L1: 400 to 500 (W), the power of the second laser light L2: 100 to 200 (W), and the scanning speed: 0.5 to 1.2 (m/sec) were set.

Through experimental researches, it has been found that the laser light L is preferably emitted under the following conditions from (1) to (8).
(1) The scanning speed in S12 is set to be slower than the scanning speed in S13.
(2) The power of the laser light L in S12 is set to be lower than the power of the laser light L in S13.

Accordingly, in S12, it is assumed that a temporal change of the temperature of the molten pool due to irradiation of the laser light L can be caused to be gentler, and a break or stretch of the metal foil 12 can be suppressed. In other words, (1) indicates that an irradiation time period of the laser light L in S12 is longer than an irradiation time period of the laser light L in S13 for the same irradiation section or for the same irradiation position on the surface Wa. In other words, (2) indicates that light density of the laser light L on the surface Wa in S12 is smaller than light density of the laser light L on the surface Wa in S13.
(3) An energy amount (total amount) applied to the processing object W by irradiation of the laser light L in S12 is caused to be larger than an energy amount (total amount) applied to the processing object W by irradiation of the laser light L in S13.

Accordingly, in S12, it is possible to form the first weld part 14F having a larger width, that is, having a larger volume than that of the second weld part 14S formed in S13. Thus, according to (3), the second weld part 14S can be easily formed to be separated from the metal foil 12 more securely, and furthermore, a break or excessive stretch of the metal foil 12 can be avoided more securely.
(4) In S13, the laser light L including the first laser light L1 and the second laser light L2 is emitted.

This is assumed to allow the second weld part 14S to be formed more efficiently while reducing a break or stretch of the metal foil 12 as much as possible in S13.
(5) In S12, the laser light L includes at least the second laser light L2.

This is assumed to allow for, in S12, inhibiting a sudden temperature change in the molten pool, and inhibiting a break or excessive stretch of the metal foil 12 more securely.

Furthermore, through the researches, the present inventors have found that (6) the laser light L preferably includes the first laser light L1 in a pulse form in S12.

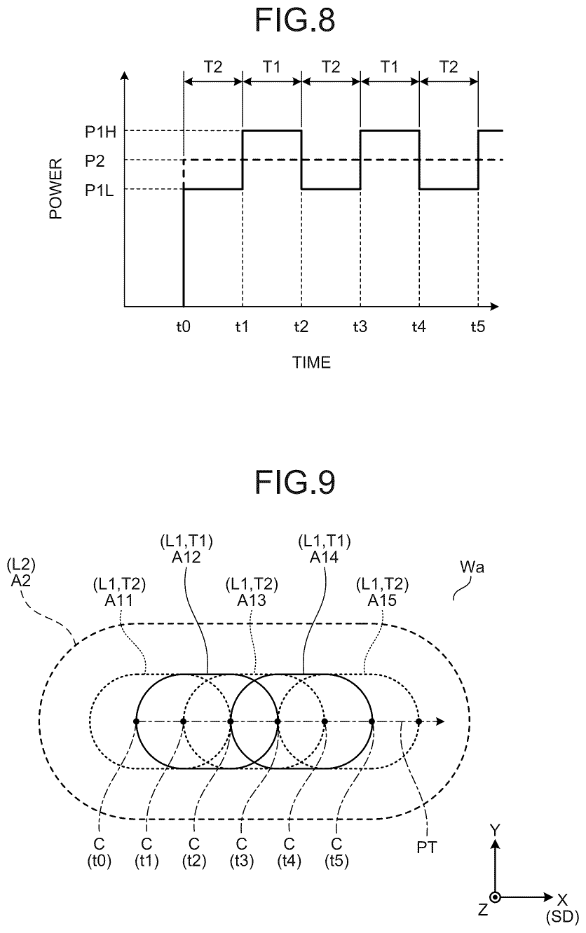

FIG. 8 is a timing chart illustrating a temporal change of the power of the laser light L in S12. In FIG. 8, a solid line indicates the power of the first laser light L1, and a dashed line indicates the power of the second laser light L2.

As illustrated in FIG. 8, in the experiment, for example, the first laser light L1 was laser light irradiated onto the processing object W in a pulse form such that a first time period T1 during which the first laser light L1 was output with a high power P1H and a second time period T2 during which the first laser light L1 was output with a low power P1L lower than the high power P1H were alternately repeated. In contrast, the second laser light L2 was laser light that is continuously emitted onto the processing object W at constant power P2. The first time period T1 and the second time period T2 were set to be the same time period, and the power P2 was a value higher than the low power P1L but lower than the high power P1H. The high power P1H is an example of first power, and the low power P1L is an example of second power.

FIG. 9 illustrates irradiation regions on the surface Wa of the laser light L the power of which is temporarily changed as in FIG. 8. In FIG. 9, a solid line indicates irradiation regions A12 and A14 by the first laser light L1 at the high power P1H, a dotted line indicates irradiation regions A11, A13, and A15 irradiated with the first laser light L1 at the low power P1L, and a dashed line indicates the irradiation region A2 irradiated with the second laser light L2. In FIG. 9, an alternate long and short dash line also indicates a locus PT of the center C (refer to FIG. 4) of the spot S of the laser light L, and positions of the center C at respective times t0 to t5 in FIG. 8 are indicated on the locus PT.

Through the experiment, in S12, it has been found that the first laser light L1 is preferably irradiated in a pulse form as illustrated in FIGS. 8 and 9 as compared with a case of irradiating with the second laser light L2 singly without irradiating with the first laser light L1, or a case of continuously irradiating with the first laser light L1 at a constant value. In a case of irradiating with the second laser light L2 singly without irradiating with the first laser light L1, and in a case in which the number of the metal foils 12 is large, for example, the power of the laser light L is insufficient, which may cause problems such as failure to form the first weld part 14F to have a required size, or increase in a time period required for forming the first weld part 14F, for example. Additionally, it has been confirmed that, in a case of continuously emitting the first laser light L1 at a constant value, variations (unevenness) tend to be caused depending on a place in the first weld part 14F. In this regard, in a case of irradiating with the first laser light L1 in a pulse form in S12, the first weld part 14F can be more preferably formed, and a break or excessive stretch of the metal foil 12 can be inhibited more securely.

As illustrated in FIG. 9, it is preferable that, (7) in S12, in two first time periods T1 each sandwiched by second time periods T2 during which the first laser light L1 has the low power P1L, the irradiation regions A12 and A14 of the first laser light L1 having the high power P1H are in contact with each other or partially overlapped with each other.

It has been found that, when the irradiation regions A12 and A14 are separated from each other on the surface Wa, variations (unevenness) may be occur in the first weld part 14F depending on a position in the first weld part 14F, and a section in which a break or excessive stretch of the metal foil 12 is less easily inhibited may be generated in some cases. The low power P1L may be zero in some cases. In other words, in the second time period T2, the first laser light L1 is not necessarily emitted.

It has been also found that (8) the second laser light L2 is preferably continuously emitted at the constant power P2 in S12.

In S12, the second laser light L2 may be emitted in a pulse form similarly to the first laser light L1. However, in a case of continuously emitting the second laser light L2 at the constant power P2 as illustrated in FIG. 8, the first weld part 14F being more preferable can be formed, and a break or excessive stretch of the metal foil 12 can be inhibited more securely.

As described above, in the present embodiment, after the first weld part 14F is formed in S12 (first step), the laser light L is irradiated onto the region including the first weld part 14F on the surface Wa to form the second weld part 14S in S13 (second step), and thus the laminated body 16 and the metal material 11 are welded together via the first weld part 14F and the second weld part 14S. According to this method, it is possible to obtain the metal joint body 10 in which a break or excessive stretch of the metal foil 12 is inhibited. In laser welding of the plurality of metal foils 12 and the metal material 11, it may be difficult to join the laminated body 16 and the metal material 11 together while inhibiting a break or excessive stretch of the metal foil 12 by performing only one process of irradiating with the laser light L even in a case in which the condition is variously changed. In this regard, according to the present embodiment, the preferable metal joint body 10 can be more easily and more securely obtained by forming the first weld part 14F that welds the plurality of metal foils 12, and forming the second weld part 14S that welds the first weld part 14F to the metal material 11 thereafter.

By performing S12 and S13 under the desired conditions as described above, it is possible to more securely obtain the preferable metal joint body 10 in which a break or excessive stretch of the metal foil 12 is inhibited.

In the embodiment described above, S12 is performed after S11, and S13 is performed thereafter, but the embodiment is not limited thereto. S11 may be performed after S12, and S13 may be performed thereafter. That is, a plurality of metal foils 12 may be integrated by forming the first weld part 14F by irradiating with the laser light L in S12, the processing object W may be set such that the integrated plurality of metal foils 12 are stacked in the Z-direction on the metal material 11 in S11, and the second weld part 14S may be formed to join the first weld part 14F and the metal material 11 together in S13 thereafter. Also in this case, the first weld part 14F has been formed before forming the second weld part 14S and thus the plurality of metal foils 12 are integrated, so that the preferable metal joint body 10 can be more easily and more securely obtained similarly to the case in which S12 is performed after S11 and S13 is performed thereafter.

### Second Embodiment

Also in the present embodiment, a metal joint body 10A (refer to FIG. 11) is formed through a process similar to that in FIG. 5. In the present embodiment, the same effect as that in the first embodiment described above can be obtained by performing S12 and S13 after S11.

However, in the present embodiment, in S12, the laser light L is irradiated multiple times onto different positions on the surface Wa of the processing object W, that is, the laminated body 16, and a plurality of the first weld parts 14F are formed.

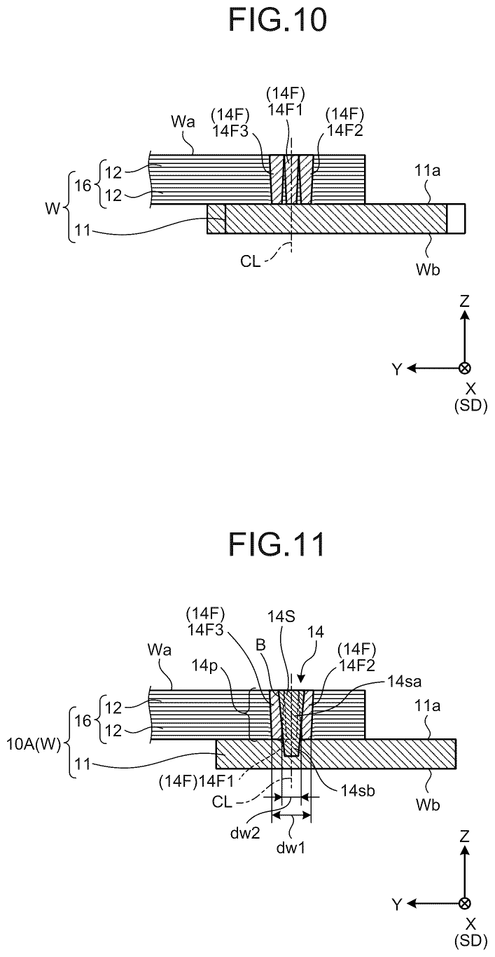

FIG. 10 is a cross-sectional view of the processing object W in a state in which the first weld parts 14F (14F1, 14F2, and 14F3) are formed in S12 in the second embodiment. In S12, the laser light L is emitted and scanning is performed in the scanning direction SD at a plurality of positions shifted from each other in the Y-direction in sections that are substantially parallel with each other and have the same length. Accordingly, as illustrated in FIG. 10, the first weld parts 14F1, 14F2, and 14F3 are formed as the first weld parts 14F, the first weld parts 14F1, 14F2, and 14F3 being shifted from each other in the Y-direction, substantially parallel with each other, and extending in the scanning direction SD with substantially the same length. In S12, in one example, the first weld part 14F1 is formed first, and the two first weld parts 14F2 and 14F3 are formed on its both sides in the Y-direction across the first weld part 14F1 thereafter. In the example of FIG. 10, the three first weld parts 14F are formed in S12, but the embodiment is not limited thereto. The number of the first weld parts 14F may be two, four, or more.

FIG. 11 is a cross-sectional view of the processing object W (metal joint body 10A) in a state in which the second weld part 14S is formed in S13 in the second embodiment. As illustrated in FIG. 11, the second weld part 14S is formed to at least partially overlap with the first weld parts 14F, penetrates the laminated body 16, and reaches the metal material 11. Thus, also in the present embodiment, the metal joint body 10A has a configuration in which the laminated body 16 and the metal material 11 are joined together by the weld part 14 including the first weld parts 14F and the second weld part 14S.

According to the present embodiment, by forming the plurality of first weld parts 14F, a large region can be more easily or more certainly secured as the region in which the first weld parts 14F are formed in the laminated body 16. Thus, the molten pool of the second weld part 14S can be more easily or more securely separated from the metal foil 12 in S13, and a break or excessive stretch of the metal foil 12 can be more securely inhibited.

Through the experiments conducted by the present inventors, it has been found that, in forming the first weld parts 14F1, 14F2, and 14F3 in S12, scanning speeds (irradiation time periods) of the laser light L may be different from each other at the time of forming the first weld parts 14F1, 14F2, and 14F3. Specifically, it has been found that the first weld part 14F in a preferable form, that is, the weld part 14 by extension, can be more efficiently formed, for example, by causing the scanning speeds of the first weld parts 14F2 and 14F3, which are to be formed later, to be higher than the scanning speed of the first weld part 14F1, which is to be formed earlier. Scanning of the first weld part 14F1 is an example of a first scan, and scanning of the first weld parts 14F2 and 14F3 is an example of a second scan. The scanning speed of the laser light L in the first scan is an example of a first speed, and the scanning speed of the laser light L in the second scan is an example of a second speed. In this example, it can be said that the irradiation time period of the laser light L in the second scan is shorter than the irradiation time period of the laser light in the first scan.

Additionally, it has been found that at least the scanning speed (first speed) in the first scan is preferably slower than the scanning speed of the laser light L in S13. That is, it is preferable that S12 includes multiple times of scanning in which the scanning speed of the laser light L is different, and includes scanning at a scanning speed slower than the scanning speed in S13 as the multiple times of scanning. In other words, it is preferable that S12 includes multiple times of irradiation for different irradiation time periods of irradiation with the laser light L, and includes irradiation for an irradiation time period longer than the irradiation time period in S13 as the multiple times of irradiation. In a case of irradiating the laser light L onto a plurality of different positions as fixed points on the surface Wa without performing scanning with the laser light L, it is preferable that S12 includes multiple times of irradiation for different irradiation time periods of irradiation with the laser light L, and includes irradiation for an irradiation time period longer than the irradiation time period in S13 as the multiple times of irradiation. Even when the scanning speed in the second scan was equivalent to the scanning speed of the laser light L in S13, the preferable weld part 14 was obtained.

Also in the present embodiment, in consideration of separating the second weld part 14S from the metal foil 12 more securely and inhibiting a break or excessive stretch of the metal foil 12 more securely, the weld part 14 is preferably formed so that the second part 14sb of the second weld part 14S projects from the penetration part 14p, including the first weld part 14F and the first part 14sa of the second weld part 14S, into the metal material 11, and the minimum width dw1 of the region in which the penetration part 14p is formed is larger than the maximum width dw2 of the second part 14sb. In a case of not performing scanning with the laser light L and irradiating the laser light L onto a fixed point in S12 and S13, the weld part 14 may be formed so that a minimum diameter (corresponding to dw1 in FIG. 11) of the region in which the penetration part 14p is formed is larger than a maximum diameter (corresponding to dw2 in FIG. 11) of the second part 14sb.

In some cases, the fact that the laser light L is irradiated multiple times in S12 and thus the weld part 14 includes a plurality of the first weld parts 14F can be confirmed by, for example, the fact that shapes of end parts in the minus direction of the Z-direction of the first weld parts 14F are left in the cross section of the metal joint body 10A including the weld part 14. The first weld part 14F is an example of a penetration part passing through the laminated body 16.

### Third Embodiment

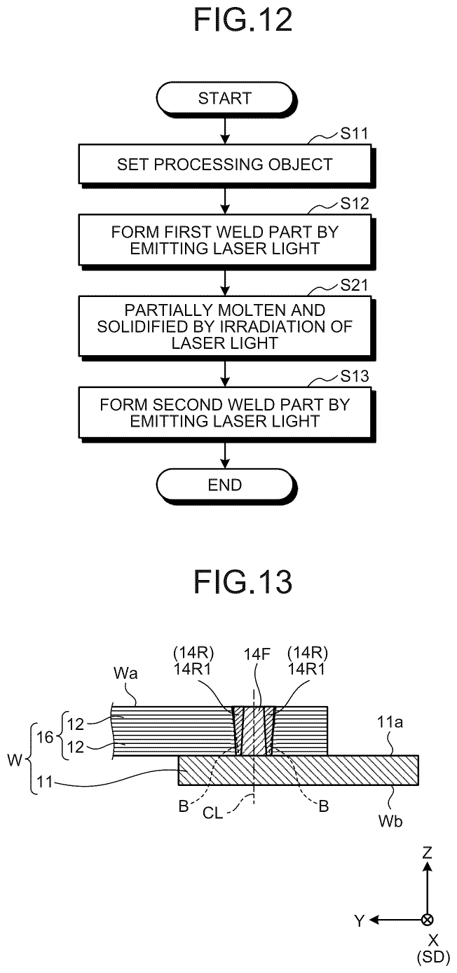

FIG. 12 is a flowchart illustrating another example of the procedure of laser welding of the processing object W by the laser processing device 100. As is clear from comparison between FIG. 12 and FIG. 5, in the present embodiment, S21 is performed after S12 described above, and after S13 described above. In S21, the processing object W is partially molten and solidified by irradiation of the laser light L. In S21, the laser light L includes the first laser light L1 and the second laser light L2 similarly to S12 and S13. S21 is an example of a third step.

FIG. 13 is a cross-sectional view of the processing object W on which a third weld part 14R1 (14R) is formed by irradiation of the laser light L, in S21, onto the processing object W in FIG. 6 after S12 in the first embodiment described above is performed. As illustrated in FIG. 13, the third weld part 14R is formed in the vicinity of the boundary B (connecting portion) between the first weld part 14F and the plurality of metal foils 12. The third weld part 14R is a part in which a portion of the first weld part 14F and portions of the plurality of metal foils 12 in the vicinity of the boundary B are molten by irradiation with the laser light L and then are cooled and solidified, that is, a welded part. The third weld part 14R is an example of the first weld part.

As described above, in welding of the metal foil 12, the metal foil 12 may be broken to form a gap in the vicinity of the boundary between the weld part and the metal foil 12, or the metal foil 12 may be stretched at a portion being in contact with the weld part to form a thin part that is excessively thin. S12 is performed under a condition with which such a gap or a thin part is not basically formed or is hardly formed. However, for example, in a case in which the number of plurality of metal foils 12 is relatively large, a gap or a thin part that is excessively thin may be locally generated depending on an individual. Thus, in the present embodiment, after S12 and before S13, the laser light L is emitted to the vicinity of the boundary B between the first weld part 14F and the metal foil 12 on the surface Wa. Accordingly, in a case in which a gap has been generated between the first weld part 14F and the metal foil 12, a portion adjacent to the gap is molten and solidified to be the third weld part 14R. In a case in which a thin part that is excessively thin has been generated at the connecting portion between the first weld part 14F and the metal foil 12, the thin part and the vicinity thereof are molten and solidified to be the third weld part 14R. According to the present embodiment, it is possible to more securely suppress generation of a gap or an excessively thin part in S21. It can be said that S21 is a step of restoring or improving a joining state in S12. In the example of FIG. 13, the laser light L is emitted while performing scanning in the scanning direction SD on the surface Wa, but the embodiment is not limited thereto. The laser light L may be irradiated onto a fixed point. In this case, the laser light L is irradiated onto a plurality of fixed points on the surface Wa.

In S21, as in the example of FIG. 13, the laser light L may be irradiated multiple times, and a plurality of the third weld parts 14R may be formed at a plurality of locations.

Furthermore, in S21, by appropriately setting an irradiation condition for the laser light L, the third weld parts 14R may be formed at a plurality of locations that are at different positions in the laminating direction of the plurality of metal foils 12.

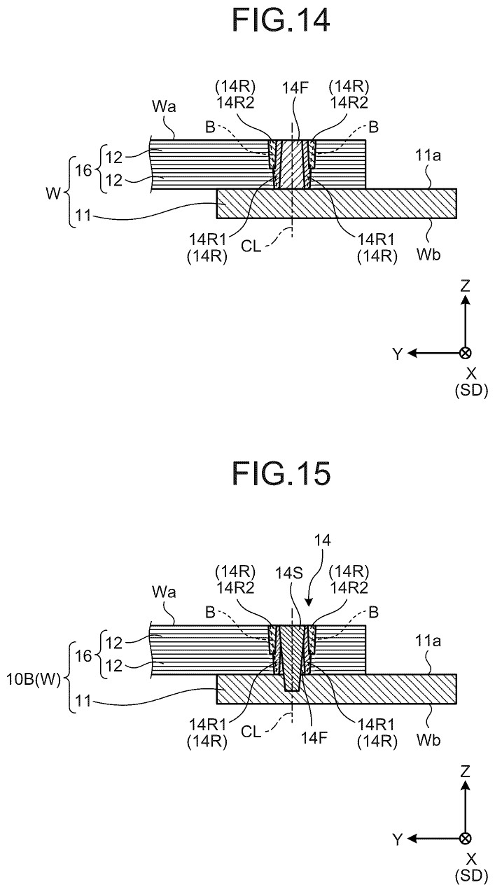

FIG. 14 is a cross-sectional view of the processing object W on which a plurality of the third weld parts 14R1 (14R) and a plurality of third weld parts 14R2 (14R) are formed by multiple times of irradiation with the laser light L in S21. In the example of FIG. 14, after the third weld parts 14R1 illustrated in FIG. 13 are formed, the laser light L is irradiated again to the vicinity of the boundary B between the first weld part 14F and the metal foil 12 on the surface Wa, so that the first weld part 14F, the third weld parts 14R1, and the metal foil 12 are partially molten, and are then cooled to be solidified, resulting in formation of the third weld part 14R2.

As illustrated in FIG. 14, the third weld parts 14R1 and the third weld parts 14R2 are different in positions in the Y-direction, in other words, positions in a direction intersecting with the Z-direction, in a direction along the surface Wa, or in a direction intersecting with the laminating direction of the plurality of metal foils 12, and different in positions in the Z-direction, in other words, positions in the laminating direction of the plurality of metal foils 12.

The position of the third weld part 14R in the direction along the surface Wa can be changed by changing the irradiating position of the spot of the laser light L on the surface Wa. In S12, the laser light L travels in the minus direction of the Z-direction while energy thereof is absorbed by the metal foil 12, so that the first weld part 14F has a tapered shape the width of which is reduced in a direction away from the surface Wa as illustrated in FIG. 6. Accordingly, the boundary B between the first weld part 14F and the plurality of metal foils 12 is often inclined to be closer to the center (in this case, the center line CL) in the width direction (Y-direction) of the first weld part 14F as being away from the surface Wa. Thus, the third weld parts 14R obtained by melting and solidifying the vicinity of the boundary B is preferably positioned to be closer to the center in the width direction of the first weld part 14F as being away from the surface Wa. In the example of FIG. 14, the center in the width direction of the third weld part 14R1 formed in the vicinity of a portion farther from the surface Wa of the boundary B is positioned to be closer to the center (center line CL) in the width direction of the first weld part 14F than the center in the width direction of the third weld part 14R2 formed in the vicinity of a portion closer to the surface Wa of the boundary B.

The position of the third weld part 14R in the laminating direction of the metal foil 12, in other words, the position in the irradiation direction of the laser light L can be changed by changing the power of the laser light L. Specifically, as the power is higher, the third weld part 14R can be formed at a position farther from the surface Wa, in other words, at a deeper position, in further other words, on a more forward side in the irradiation direction. That is, as the power is lower, the third weld part 14R can be formed at a position closer to the surface Wa, in other words, at a shallower position, in more other words, on a more backward side in the irradiation direction.

In the example of FIG. 14, an end part in the minus direction of the Z-direction as a bottom part of the third weld part 14R1 is positioned farther from the surface Wa than an end part in the minus direction of the Z-direction as a bottom part of the third weld part 14R2 corresponding to a shape of the boundary B. That is, the third weld part 14R2 is positioned on a more backward side in the irradiation direction of the laser light L than the third weld part 14R1. In the examples of FIGS. 13 and 14, irradiation of the laser light L to form the third weld part 14R1 in S21 is an example of first irradiation, and irradiation of the laser light L to form the third weld part 14R2 in S21 thereafter is an example of third irradiation and fourth irradiation.

The third weld part 14R2 may also be formed such that the laser light L is irradiated to the vicinity of the boundary between the third weld part 14R1 and the metal foil 12 on the surface Wa, and the third weld part 14R1 and the metal foil 12 are partially molten and cooled to be solidified. In this case, irradiation of the laser light L to form the third weld part 14R2 in S21 is an example of second irradiation. In a case in which the boundary B between the first weld part 14F and the metal foil 12 and the boundary between the third weld part 14R1 and the metal foil 12 are close to each other or in line with each other, irradiation with the laser light L to form the third weld part 14R2 in S21 can be an example of the third irradiation and the fourth irradiation, and can be an example of the second irradiation in some cases.

In the example of FIG. 14, the third weld parts 14R1 and 14R2 are formed at four points by four times of irradiation of the laser light L, but are not limited thereto. The number of the third weld parts 14R (that is, the number of times of irradiation of the laser light L in S21), and specs such as a position, a width, a depth, and a length thereof can be variously set. In the example of FIG. 14, two stages of the third weld parts 14R1 and 14R2 the positions of which are different in the laminating direction (irradiation direction) of the metal foil 12 are formed, but three or more stages of the third weld parts 14R the positions of which are different in the laminating direction may be formed. Furthermore, in the example of FIG. 14, the third weld part 14R2 positioned on the more backward side in the irradiation direction than the third weld part 14R1 is formed after the third weld part 14R1, but the order of forming the third weld parts 14R is not limited thereto. The third weld parts 14R can be formed in various orders. For example, the third weld part 14R1 can be formed after the third weld part 14R2.

FIG. 15 is a cross-sectional view of the processing object W (a metal joint body 10B) on which the second weld part 14S is formed by, after the third weld parts 14R1 and 14R2 illustrated in FIG. 14 are formed in S21, irradiating with the laser light L in S14. As illustrated in FIG. 15, also in the present embodiment, the metal joint body 10B has a configuration in which the laminated body 16 is joined with the metal material 11 by the weld part 14 including the first weld part 14F, the second weld part 14S, and the third weld part 14R. In a case of cutting each of the metal joint bodies 10A and 10B to form the same cross section as that in FIG. 15, the first weld part 14F, the second weld part 14S, and the third weld parts 14R (14R1, 14R2) may be distinguished from each other as different regions, for example, based on a difference in surface roughness at the cross section, a difference in properties such as crystal orientation and a particle diameter, a difference in luminance in an image obtained by photographing the cross section, and the like. The fact that the cross section has a plurality of regions having such differences may serve as an evidence that the method according to the present embodiment is performed.

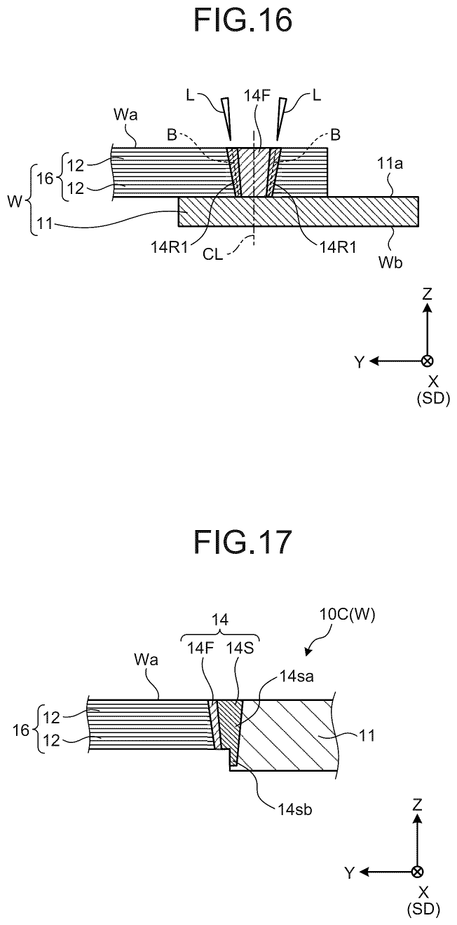

In S21, the laser light L may be emitted in a direction inclined with respect to the irradiation direction of the laser light in S12, that is, the minus direction of the Z-direction. FIG. 16 is a cross-sectional view of the processing object W on which the third weld part 14R1 (14R) is formed in this case. As described above, the boundary B is often inclined to be closer to the center (center line CL) in the width direction of the first weld part 14F as being away from the surface Wa. Thus, by emitting the laser light L at an angle inclined with respect to the minus direction of the Z-direction along the inclination of the boundary B, the third weld part 14R may be more efficiently formed along the boundary B. Additionally, although not illustrated, the third weld part 14R other than the third weld part 14R1 such as the third weld part 14R2 may also be formed by emitting the laser light L in the direction inclined with respect to the minus direction of the Z-direction along the boundary B. The irradiation direction of the laser light L can be changed or set by controlling or setting angles of the mirrors 126a and 126b of the galvanoscanner 126, or controlling or setting an inclination angle of the optical head 120 with respect to a support base, for example.

In the examples of FIGS. 12 to 15, S21 is performed after S12 and before S13, but is not limited thereto. S21 may be performed after S13.

### Conditions for Performing S21

Based on experimental researches, the present inventors have found that the preferable third weld part 14R can be formed by performing irradiation with the laser light L under predetermined conditions in S21 as described above. In the experiment, at all of S12, S21, and S13, the first weld part 14F, the second weld part 14S, and the third weld part 14R are formed by scanning the spot S of the laser light L on the surface Wa. By the scanning, the first weld part 14F, the second weld part 14S, and the third weld part 14R can be formed over a wider range and in a shorter time period.

The experiment was conducted for a case in which the metal material 11 and twenty metal foils 12 are both made of aluminum-based metal. At all of S12, S21, and S13, the diameter d1 of the spot S1 of the first laser light L1: 20 to 40 (μm), and the diameter d2 of the spot S2 of the second laser light L2: 300 to 350 (μm) were set. In S12, the power of the first laser light L1: 80 to 200 (W), the power of the second laser light L2: 100 to 200 (W), and the scanning speed: 0.1 to 0.2 (m/sec) were set. In S21, the power of the first laser light L1: 80 to 350 (W), the power of the second laser light L2: 100 to 200 (W), and the scanning speed: 0.5 to 1.5 (m/sec) were set. In S13, the power of the first laser light L1: 300 to 500 (W), the power of the second laser light L2: 100 to 200 (W), and the scanning speed: 0.5 to 1.2 (m/sec) were set.

Through experimental researches, it has been found that the laser light L is preferably emitted under the following conditions from (9) to (11).
(9) The scanning speed in S21 is delayed as compared with the scanning speed in S12.
(10) An energy amount (total amount) applied to the processing object W by irradiation of the laser light L in each time of irradiation to form each of the third weld parts 14R in S21 is caused to be smaller than an energy amount (total amount) applied to the processing object W by irradiation of the laser light L in S12.

According to (9) and (10) described above, the width in the direction (Y-direction) orthogonal to the scanning direction of the third weld part 14R can be caused to be smaller than the width in the direction orthogonal to the scanning direction of the first weld part 14F, and the third weld part 14R having an appropriate width, which is not too wide, can be formed in the vicinity of the boundary B. Accordingly, wasteful energy consumption can be suppressed. In a case of performing irradiation of the laser light L multiple times in S21, the scanning speed may be varied for each time of irradiation to form the third weld part 14R.
(11) The power of the laser light L in S21 is caused to be lower than the power of the laser light L in S13.

Accordingly, the third weld part 14R having an appropriate depth and not passing through the laminated body 16 can be formed in S21.

The embodiments of the present invention have been exemplified above, but the embodiments are merely examples, and do not intend to limit the scope of the invention. The embodiments described above can be implemented in various other forms, and can be variously omitted, replaced, combined, or modified without departing from the gist of the invention. Specs such as each configuration or shape (a structure, a type, a direction, a model, a size, a length, a width, a thickness, a height, the number, disposition, a position, a material, and the like) can be appropriately modified to be implemented.

For example, the optical head may be configured to be movable relatively to a stage holding the processing object. In this case, the optical head may or may not include the galvanoscanner.

The metal foil may include a thin layer of another material such as a plating layer on the surface thereof.

It is not necessary to perform scanning with the laser light on the surface of the processing object. The present invention can also be applied to a case of emitting the laser light onto a fixed point on the surface. In this case, the laser light may be emitted onto a plurality of fixed points on the surface.

As illustrated in FIG. 17, the configuration according to the present invention can also be applied to the processing object W (metal joint body 10C) in which the metal material 11 and the laminated body 16 do not overlap with each other in the laminating direction (Z-direction) of the plurality of metal foils 12 but are arranged side by side in the direction (Y-direction) intersecting with the laminating direction. In this case, the weld part 14 including the first weld part 14F and the second weld part 14S is formed at the boundary portion between the metal material 11 and the laminated body 16, and the metal material 11 is joined with the laminated body 16 via the weld part 14 to configure the metal joint body 10C.

The present invention can also be implemented in the following embodiments.
(1) A laser welding method for welding a metal material and a laminated body of metal foil together by irradiation with laser light, the laser welding method including: a first step of forming a first weld part in which at least a plurality of the metal foils included in the laminated body are welded by emitting the laser light; and a second step of welding the laminated body and the metal material together by irradiating the laser light onto a region at least partially including the first weld part.
(2) The laser welding method according to (1), further including, after the first step, a third step of, by irradiation with the laser light, melting and solidifying either a portion adjacent to a gap between the first weld part and the metal foil or a connecting portion between the first weld part and the metal foil.
(3) The laser welding method according to (2), wherein the third step is performed before the second step.
(4) The laser welding method according to (2), wherein the third step is performed after the second step.
(5) The laser welding method according to any one of (1) to (4), wherein, in at least one of the first step and the second step, the laser light includes first laser light and second laser light having a shorter wavelength than a wavelength of the first laser light.
(6) The laser welding method according to any one of (2) to (4), wherein, in the third step, the laser light includes first laser light and second laser light having a shorter wavelength than a wavelength of the first laser light.
(7) The laser welding method according to (5) or (6), wherein the wavelength of the first laser light is equal to or larger than 800 nm and equal to or smaller than 1200 nm, and the wavelength of the second laser light is equal to or smaller than 550 nm.
(8) The laser welding method according to (7), wherein the wavelength of the second laser light is equal to or larger than 400 nm and equal to or smaller than 500 nm.
(9) The laser welding method according to any one of (1) to (8), wherein irradiation with the laser light in the first step includes multiple times of irradiation to different positions on a surface of the laminated body.
(10) The laser welding method according to any one of (5) to (8), wherein a size of a spot of the second laser light is larger than a size of a spot of the first laser light.
(11) The laser welding method according to any one of (1) to (10), wherein all of the plurality of metal foils included in the laminated body are welded in the first step.
(12) The laser welding method according to any one of (1) to (11), wherein, in the first step, the first weld part that is not welded to the metal material is formed by irradiating with the laser light.
(13) The laser welding method according to any one of (1) to (12), wherein, in both the first step and the second step, scanning is performed with the laser light on the laminated body.
(14) The laser welding method according to (13), wherein the first step includes scanning with the laser light at a scanning speed slower than a scanning speed with the laser light in the second step.
(15) The laser welding method according to any one of (1) to (14), wherein the first step includes multiple times of scanning with the laser light at different scanning speeds.
(16) The laser welding method according to any one of (1) to (15), wherein the first step includes a first scan with the laser light at a first speed, and a second scan with the laser light at a second speed faster than the first speed, the second scan being performed after the first scan.
(17) The laser welding method according to any one of (1) to (16), wherein the first step includes multiple times of scanning with the laser light at positions shifted from each other in a direction intersecting with a scanning direction with the laser light.
(18) The laser welding method according to any one of (1) to (17), wherein the laser light in the first step includes laser light emitted in a pulse form.
(19) The laser welding method according to (18), wherein the first step includes a first time period during which the laser light is emitted in a pulse form with a first power, and a second time period during which the laser light is emitted in a pulse form with a second power lower than the first power or is not emitted, the first time period and the second time period being alternately performed, and two regions onto which the laser light is irradiated in a pulse form in two first time periods before and after the second time period are in contact with each other or partially overlapped with each other on the laminated body.
(20) The laser welding method according to any one of (1) to (19), wherein the laser light in the first step includes laser light that is continuously emitted.
(21) The laser welding method according to any one of (1) to (20), wherein the laser light includes first laser light and second laser light having a wavelength shorter than a wavelength of the first laser light, and at least the first laser light in the first step is emitted in a pulse form.
(22) The laser welding method according to any one of (1) to (21), wherein in the second step, a projecting part is formed in the metal material, the projecting part projecting from a part of the first weld part passing through the laminated body into the metal material, and a minimum width of a region in which the first weld part is formed is larger than a maximum width of the projecting part, or a minimum diameter of a region in which the first weld part is formed is larger than a maximum diameter of the projecting part.
(23) The laser welding method according to any one of (1) to (22), wherein a width or a diameter of the first weld part is larger than a width or a diameter of a spot of the laser light irradiated in the second step.
(24) The laser welding method according to any one of (1) to (23), wherein a power of the laser light in the first step is lower than a power of the laser light in the second step.
(25) The laser welding method according to any one of (1) to (24), wherein an energy amount of the laser light irradiated in the first step is larger than an energy amount of the laser light irradiated in the second step.
(26) The laser welding method according to any one of (2) to (4) and (6), wherein irradiation of the laser light in the third step includes multiple times of irradiation to respectively melt and solidify different parts.
(27) The laser welding method according to (26), wherein the multiple times of irradiation includes: a first irradiation, and a second irradiation to melt and solidify either: a portion adjacent to a gap between the first weld part, formed by the first irradiation, and the metal foils, or a connecting portion between the first weld part, formed by the first irradiation, and the metal foils.
(28) The laser welding method according to any one of (2) to (4), (6), (26), and (27), wherein irradiation of the laser light in the third step includes multiple times of irradiation to melt and solidify respective parts at different positions in a laminating direction of the metal foil.
(29) The laser welding method according to (28), wherein the multiple times of irradiation includes first irradiation, and third irradiation to melt and solidify a part on a more backward side in an irradiation direction of the laser light than the part solidified by the first irradiation.
(30) The laser welding method according to any one of (2) to (4), (6), and (26) to (29), wherein irradiation of the laser light in the third step includes multiple times of irradiation at different irradiation positions of the laser light for the metal foil.
(31) The laser welding method according to any one of (2) to (4), (6), and (26) to (30), wherein irradiation of the laser light in the third step includes multiple times of irradiation with different power of the laser light.
(32) The laser welding method according to (31), wherein the multiple times of irradiation includes first irradiation and fourth irradiation after the first irradiation, the fourth irradiation in which a power of the laser light is lower than a power of the laser light in the first irradiation.
(33) The laser welding method according to any one of (2) to (4), (6), and (26) to (32), wherein a power of the laser light in the third step is lower than a power of the laser light in the second step.
(34) The laser welding method according to any one of (2) to (4), (6), and (26) to (33), wherein an energy amount per one time of irradiation of the laser light in the third step is smaller than an energy amount of the laser light emitted in the first step.
(35) The laser welding method according to any one of (2) to (4), (6), and (26) to (34), wherein scanning is performed with the laser light on the laminated body in the third step.
(36) The laser welding method according to (35), wherein scanning is performed with the laser light on the laminated body in the first step, and the third step includes scanning with the laser light at a scanning speed higher than a scanning speed with the laser light in the first step.
(37) The laser welding method according to any one of (2) to (4), (6), and (26) to (36), wherein, in the third step, the laser light is emitted in a direction inclined with respect to an irradiation direction of the laser light in the first step.
(38) A metal joint body comprising: a metal material; a laminated body of metal foil disposed on the metal material; and a weld part at which the laminated body and the metal material are welded together, the weld part including a penetration part penetrating the laminated body in a laminating direction of the metal foil and a projecting part projecting from the penetration part into the metal material, wherein a minimum width of a region in which the penetration part is formed is larger than a maximum width of the projecting part, or a minimum diameter of the region in which the penetration part is formed is larger than a maximum diameter of the projecting part.
(39) The metal joint body according to (38), wherein the weld part includes a plurality of penetration parts as the penetration part.

The present invention can be used for a laser welding method and a metal joint body.

### Reference Signs List

1 BATTERY (ELECTRIC PRODUCT); 10, 10A, 10B, 10C METAL JOINT BODY; 11, 11m, 11p METAL MATERIAL; 11a SURFACE; 12 METAL FOIL; 13m ANODE MATERIAL; 13p CATHODE MATERIAL; 14 WELD PART; 14F, 14F1, 14F2, 14F3 FIRST WELD PART (PENETRATION PART); 14p PENETRATION PART; 14S SECOND WELD PART; 14R, 14R1, 14R2 THIRD WELD PART; 14sa FIRST PART (PENETRATION PART); 14sb SECOND PART (PROJECTING PART); 15 SEPARATOR; 16 LAMINATED BODY; 20 EXTERIOR MATERIAL; 20a HOUSING CHAMBER; 100 LASER PROCESSING DEVICE; 111, 112 LASER DEVICE; 120 OPTICAL HEAD; 121, 121-1, 121-2 COLLIMATING LENS; 122 CONDENSING LENS; 123 MIRROR; 124 FILTER; 126 GALVANOSCANNER; 126a, 126b MIRROR; 131, 132 OPTICAL FIBER; A11, A12, A13, A14, A15 IRRADIATION REGION; A2 IRRADIATION REGION; A2f REGION; B BOUNDARY; C CENTER; CL CENTER LINE; d, d1, d2 DIAMETER; dw1 MINIMUM WIDTH (MINIMUM DIAMETER); dw2 MAXIMUM WIDTH (MAXIMUM DIAMETER); L LASER LIGHT; L1 FIRST LASER LIGHT; L2 SECOND LASER LIGHT; P1H HIGH POWER; P1L LOW POWER; P2 POWER; PT LOCUS; S, S1, S2 SPOT; S1a, S2a OUTER EDGE; S12 FIRST PROCESS; S13 SECOND PROCESS; S21 THIRD PROCESS; t0 to t5 TIME; T1 FIRST TIME PERIOD; T2 SECOND TIME PERIOD; W PROCESSING OBJECT; Wa SURFACE; Wb BACK SURFACE; X DIRECTION; Y DIRECTION; and, Z DIRECTION.

1. A laser welding method for welding a metal material and a laminated body of metal foil together by irradiation with laser light, the laser welding method comprising:
a first step of forming a first weld part in which at least a plurality of the metal foils included in the laminated body are welded by emitting the laser light; and
a second step of welding the laminated body and the metal material together by irradiating the laser light onto a region at least partially including the first weld part.

2. The laser welding method according to claim 1, further comprising, after the first step, a third step of, by irradiation with the laser light, melting and solidifying either a portion adjacent to a gap between the first weld part and the metal foil or a connecting portion between the first weld part and the metal foil.

3. The laser welding method according to claim 2, wherein the third step is performed before the second step.

4. The laser welding method according to claim 2, wherein the third step is performed after the second step.

5. The laser welding method according to claim 1, wherein, in at least one of the first step and the second step, the laser light includes first laser light and second laser light having a shorter wavelength than a wavelength of the first laser light.

6. The laser welding method according to claim 2, wherein, in the third step, the laser light includes first laser light and second laser light having a shorter wavelength than a wavelength of the first laser light.

7. The laser welding method according to claim 5, wherein
the wavelength of the first laser light is equal to or larger than 800 nm and equal to or smaller than 1200 nm, and
the wavelength of the second laser light is equal to or smaller than 550 nm.

8. The laser welding method according to claim 7, wherein the wavelength of the second laser light is equal to or larger than 400 nm and equal to or smaller than 500 nm.

9. The laser welding method according to claim 1, wherein irradiation with the laser light in the first step includes multiple times of irradiation to different positions on a surface of the laminated body.

10. The laser welding method according to claim 5, wherein a size of a spot of the second laser light is larger than a size of a spot of the first laser light.

11. The laser welding method according to claim 1, wherein all of the plurality of metal foils included in the laminated body are welded in the first step.

12. The laser welding method according to claim 1, wherein, in the first step, the first weld part that is not welded to the metal material is formed by irradiating with the laser light.

13. The laser welding method according to claim 1, wherein, in both the first step and the second step, scanning is performed with the laser light on the laminated body.

14. The laser welding method according to claim 13, wherein the first step includes scanning with the laser light at a scanning speed slower than a scanning speed with the laser light in the second step.

15. The laser welding method according to claim 1, wherein the first step includes multiple times of scanning with the laser light performed at different scanning speeds.

16. The laser welding method according to claim 1, wherein the first step includes a first scan with the laser light at a first speed, and a second scan with the laser light at a second speed faster than the first speed, the second scan being performed after the first scan.

17. The laser welding method according to claim 1, wherein the first step includes multiple times of scanning with the laser light at positions shifted from each other in a direction intersecting with a direction in which the scanning with the laser light is performed.

18. The laser welding method according to claim 1, wherein the laser light in the first step includes laser light emitted in a pulse form.

19. The laser welding method according to claim 18, wherein
the first step comprises a first time period during which the laser light is emitted in a pulse form with a first power, and a second time period during which the laser light is emitted in a pulse form with a second power lower than the first power or is not emitted, the first time period and the second time period being alternately performed, and
two regions onto which the laser light is irradiated in a pulse form in two first time periods before and after the second time period are in contact with each other or partially overlapped with each other on the laminated body.

20. The laser welding method according to claim 1, wherein the laser light in the first step includes laser light that is continuously emitted.

21. The laser welding method according to claim 1, wherein
the laser light includes first laser light and second laser light having a wavelength shorter than a wavelength of the first laser light, and
at least the first laser light in the first step is emitted in a pulse form.

22. The laser welding method according to claim 1, wherein
in the second step, a projecting part is formed in the metal material, the projecting part projecting from a part of the first weld part passing through the laminated body into the metal material, and
a minimum width of a region in which the first weld part is formed is larger than a maximum width of the projecting part, or a minimum diameter of a region in which the first weld part is formed is larger than a maximum diameter of the projecting part.

23. The laser welding method according to claim 1, wherein a width or a diameter of the first weld part is larger than a width or a diameter of a spot of the laser light irradiated in the second step.

24. The laser welding method according to claim 1, wherein a power of the laser light in the first step is lower than a power of the laser light in the second step.

25. The laser welding method according to claim 1, wherein an energy amount of the laser light irradiated in the first step is larger than an energy amount of the laser light irradiated in the second step.

26. The laser welding method according to claim 2, wherein irradiation of the laser light in the third step includes multiple times of irradiation to melt and solidify different parts.

27. The laser welding method according to claim 26, wherein the multiple times of irradiation includes:
a first irradiation, and
a second irradiation to melt and solidify either:
a portion adjacent to a gap between the first weld part, formed by the first irradiation, and the metal foil, or
a connecting portion between the first weld part, formed by the first irradiation, and the metal foil.

28. The laser welding method according to claim 2, wherein irradiation of the laser light in the third step includes multiple times of irradiation to melt and solidify respective parts at different positions in a laminating direction of the metal foil.

29. The laser welding method according to claim 28, wherein the multiple times of irradiation includes:
a first irradiation, and
a third irradiation to melt and solidify a part on a more backward side in an irradiation direction of the laser light than the part solidified by the first irradiation.

30. The laser welding method according to claim 2, wherein irradiation of the laser light in the third step includes multiple times of irradiation at different irradiation positions of the laser light for the metal foil.

31. The laser welding method according to claim 2, wherein irradiation of the laser light in the third step includes multiple times of irradiation with different power of the laser light.

32. The laser welding method according to claim 31, wherein the multiple times of irradiation includes first irradiation and fourth irradiation after the first irradiation, the fourth irradiation in which a power of the laser light is lower than a power of the laser light in the first irradiation.

33. The laser welding method according to claim 2, wherein a power of the laser light in the third step is lower than a power of the laser light in the second step.

34. The laser welding method according to claim 2, wherein an energy amount per one time of irradiation of the laser light in the third step is smaller than an energy amount of the laser light emitted in the first step.

35. The laser welding method according to claim 2, wherein, in the third step, scanning is performed with the laser light on the laminated body.

36. The laser welding method according to claim 35, wherein
in the first step, scanning is performed with the laser light on the laminated body, and
the third step includes scanning with the laser light at a scanning speed higher than a scanning speed with the laser light in the first step.

37. The laser welding method according to claim 2, wherein, in the third step, the laser light is emitted in a direction inclined with respect to an irradiation direction of the laser light in the first step.

38. A metal joint body comprising:
a metal material;
a laminated body of metal foil disposed on the metal material; and
a weld part at which the laminated body and the metal material are welded together, the weld part including
a penetration part penetrating the laminated body in a laminating direction of the metal foil and
a projecting part projecting from the penetration part into the metal material, wherein
a minimum width of a region in which the penetration part is formed is larger than a maximum width of the projecting part, or a minimum diameter of the region in which the penetration part is formed is larger than a maximum diameter of the projecting part.

39. The metal joint body according to claim 38, wherein the weld part includes a plurality of penetration parts as the penetration part.
